(19) United States
(12) Patent Application Publication
(10) Pub. No.: US 2006/0078709 A1
(43) Pub. Date: Apr. 13, 2006

(54) Process for controlling wettability of electrochemical plating component surfaces

(76) Inventor: Brian C. Lue, Mountain View, CA (US)

Correspondence Address: PATTERSON & SHERIDAN, LLP, 3040 POST OAK BOULEVARD, SUITE 1500, HOUSTON, TX, 77056, US

(21) Appl. No.: 10/960,332

(22) Filed: Oct. 7, 2004

(51) Int. Cl. B05D 3/00; B05D 3/04; B29C 71/04; B32B 3/02

(52) U.S. Cl. 428/66.6; 427/532; 427/377

(57) ABSTRACT

A method for modifying the surface of an electrochemical plating component by treatment with ultraviolet light and/or ozone to improve the wettability of the surface. A method for controlling the wettability of the surface of an electrochemical plating component by rapidly cooling a melted polymer employed to form the surface. The electrochemical plating components produced from these methods of modifying and/or controlling surface wettability.

### BACKGROUND OF THE INVENTION

1. Field of the Invention

Embodiments of the present invention generally relate to a process for modifying the surface of electrochemical plating component surfaces to minimize defects in processed substrates.

2. Description of the Related Art

Metallization of high aspect ratio 90 nm and smaller sized features is a foundational technology for future generations of integrated circuit manufacturing processes. Metallization of these features is generally accomplished via an electrochemical plating (ECP) process. However, electrochemical plating of these features presents several challenges to conventional gap fill methods and apparatuses. One such problem, for example, is that gas bubbles form in electrochemical plating solutions during the deposition process. Research has shown that a primary cause of plating defects is the presence of air bubbles on the surface of the substrate being plated. These air bubbles prevent the electrolyte solution from contacting the substrate surface at that particular location, and therefore, prevent plating at that location, which in turn forms a defect in the plated layer. Bubbles adhering to the substrate surface during immersion may also dislodge and travel across the surface of the substrate once it's immersed in the plating solution, which may generate multiple defects at multiple locations along the bubble path. ECP apparatuses are designed to prevent bubble formation and remove gas bubbles once formed, but the efficiency of bubble removal is hindered by any tendency of the bubbles to adhere to sub-solution level surfaces of plating system components. One such surface is on the contact ring, which serves to distribute electrical current to the substrate during metal deposition.

What is desired, therefore, is an improved ECP apparatus in which the surface of the contact ring is adapted to minimize adherence of gas bubbles thereto during the metal deposition process.

### SUMMARY OF THE INVENTION

The present invention generally provides a method for modifying the surface of an electrochemical plating component by treatment with ultraviolet light and/or ozone to improve the wettability of the surface. The present invention also provides a method for controlling the wettability of the surface of an electrochemical plating component by rapidly cooling a melted polymer employed to form the surface. In addition, the present invention encompasses the electrochemical plating components produced from the embodiments of this invention.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top plan view of one embodiment of an electrochemical plating system of the invention.

FIG. 2 illustrates a partial perspective and sectional view of an exemplary plating cell used in the plating system of the invention.

FIG. 3 illustrates a sectional view of a plating cell and head assembly positioned in a processing position.

FIG. 4 illustrates a perspective view of an exemplary contact ring of the invention.

FIG. 5 illustrates a exemplary ultraviolet light treatment process.

FIG. 6 illustrates a exemplary ozone treatment process.

FIG. 7 is a flow diagram describing an exemplary process sequence for controlling the wettability of a polymer surface.

### DETAILED DESCRIPTION

The present invention generally encompasses a method for modifying the wettability of a contact ring polymer surface by irradiating the polymer surface of a contact ring with ultraviolet radiation. Another embodiment generally involves a method for modifying the wettability of a contact ring polymer surface by exposing the polymer surface of a contact ring to ozone. A third embodiment generally pertains to controlling the wettability of a contact ring polymer surface by rapidly solidifying a liquefied polymer surface of a contact ring. The present invention also includes the contact rings having improved surface wettability resulting from application to the abovementioned methods.

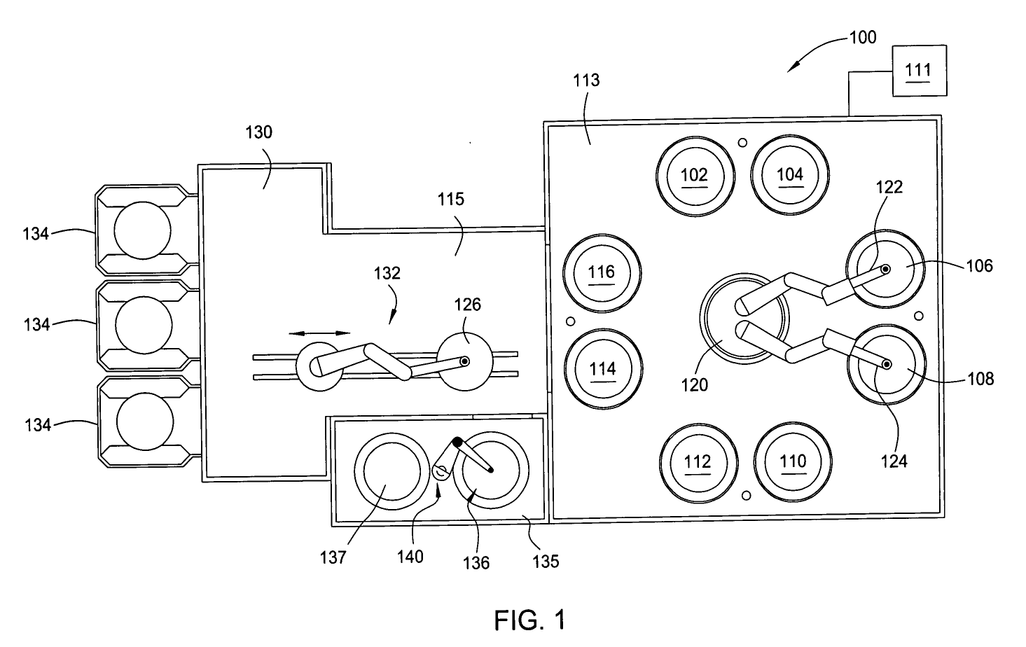

FIG. 1 illustrates a top plan view of an ECP system 100 of the invention. ECP system 100 includes a factory interface 130, which is also generally termed a substrate loading station. Factory interface 130 is configured to interface with substrate containing cassettes 134. A robot 132 is positioned in factory interface 130 and is configured to access substrates 126 contained in the cassettes 134. Factory interface 130 includes robot 132, which extends into a link tunnel 115 that connects factory interface 130 to processing mainframe or platform 113. The position of robot 132 allows the robot to access substrate cassettes 134, to retrieve substrates 126 therefrom, and then deliver the substrates 126 to one of the processing cells 114, 116 positioned on the mainframe 113, or alternatively, to the annealing station 135. Similarly, robot 132 may be used to retrieve substrates 126 from the processing cells 114, 116 or the annealing station 135 after a substrate processing sequence is complete. In this situation robot 132 may deliver the substrate 126 back to one of the cassettes 134 for removal from system 100.

The anneal station 135 generally includes a two position annealing chamber, wherein a cooling plate/position 136 and a heating plate/position 137 are positioned adjacently with a substrate transfer robot 140 positioned proximate thereto, e.g., between the two positions. The robot 140 is generally configured to move substrates 126 between the respective heating 137 and cooling plates 136. Further, although the annealing station 135 is illustrated as being positioned such that it is accessed from the link tunnel 115, embodiments of the invention are not limited to any particular configuration or placement. As such, the annealing station may be positioned in communication with the mainframe 113.

As mentioned above, ECP system 100 also includes a processing mainframe 113 having a substrate transfer robot 120 centrally positioned thereon. Robot 120 generally includes one or more arms/blades 122, 124 configured to support and transfer substrates 126 thereon. Additionally, the robot 120 and the accompanying blades 122, 124 are generally configured to extend, rotate, and vertically move so that the robot 120 may insert and remove substrates 126 to and from a plurality of processing locations 102, 104, 106, 108, 110, 112, 114, 116 positioned on the mainframe 113. Similarly, factory interface robot 132 also includes the ability to rotate, extend, and vertically move its substrate support blade, while also allowing for linear travel along the robot track that extends from the factory interface 130 to the mainframe 113. Generally, process locations 102, 104, 106, 108, 110, 112, 114, 116 may be any number of processing cells utilized in an electrochemical plating platform. More particularly, the process locations may be configured as electrochemical plating cells, rinsing cells, bevel clean cells, spin rinse dry cells, substrate surface cleaning cells, electroless plating cells, metrology inspection stations, and/or other processing cells that may be beneficially used in conjunction with a plating platform. Each of the respective processing cells and robots are generally in communication with a process controller 111, which may be a microprocessor-based control system configured to receive inputs from both a user and/or various sensors positioned on the system 100 and appropriately control the operation of system 100 in accordance with the inputs.

In the exemplary plating system illustrated in FIG. 1, the processing locations may be configured as follows. Processing locations 114 and 116 may be configured as an interface between the wet processing stations on the mainframe 113 and the dry processing regions in the link tunnel 115, annealing station 135, and the factory interface 130. The processing cells located at the interface locations may be spin rinse dry cells and/or substrate cleaning cells. More particularly, each of locations 114 and 116 may include both a spin rinse dry cell and a substrate cleaning cell in a stacked configuration. Locations 102, 104, 110, and 112 may be configured as plating cells, either electrochemical plating cells or electroless plating cells, for example. Locations 106, 108 may be configured as substrate bevel cleaning cells. Additional configurations and implementations of an electrochemical processing system are illustrated in commonly assigned U.S. patent application Ser. No. 10/438,624, entitled “Multi-Chemistry Electrochemical Processing System,” filed on May 14, 2003, which is incorporated herein by reference in its entirety to the extent not inconsistent herewith.

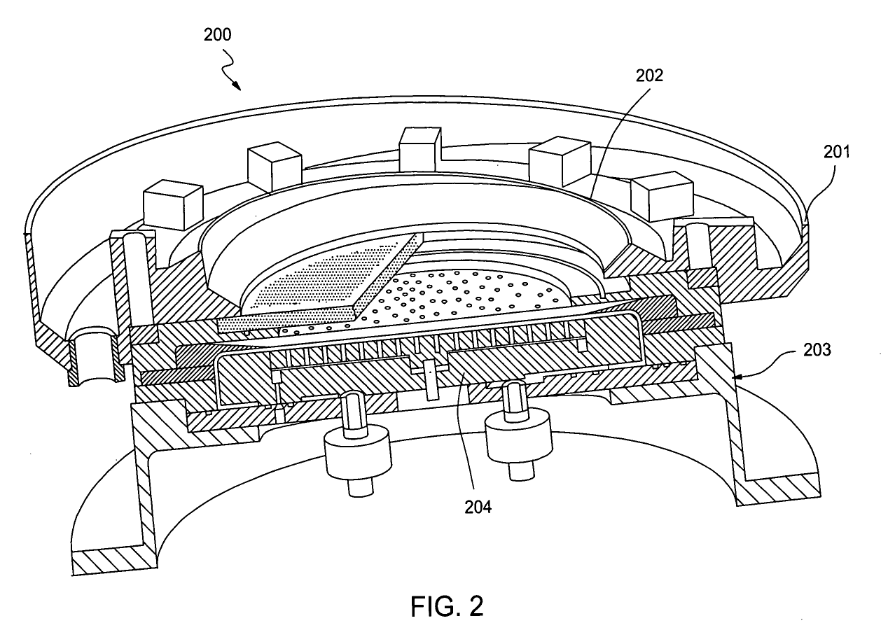

FIG. 2 illustrates a partial perspective and sectional view of an exemplary plating cell 200 that may be implemented in processing locations 102, 104, 110, and/or 112. The electrochemical plating cell 200 generally includes an outer basin 201 and an inner basin 202 positioned within outer basin 201. Inner basin 202 is generally configured to contain a plating solution that is used to plate a metal, e.g., copper, onto a substrate during an electrochemical plating process. During the plating process, the plating solution is generally continuously supplied to inner basin 202 (at about 1 gallon per minute for a 10 liter plating cell, for example), and therefore, the plating solution continually overflows the uppermost point (generally termed a “weir”) of inner basin 202 and is collected by outer basin 201 and drained therefrom for chemical management and recirculation. Plating cell 200 is generally positioned at a tilt angle, i.e., the frame portion 203 of plating cell 200 is generally elevated on one side such that the components of plating cell 200 are tilted between about 3° and about 30°, or generally between about 4° and about 10° for optimal results. The frame member 203 of plating cell 200 supports an annular base member 204 on an upper portion thereof. Since frame member 203 is elevated on one side, the upper surface of base member 204 is generally tilted from the horizontal at an angle that corresponds to the angle of frame member 203 relative to a horizontal position. The exemplary plating cell is further illustrated in commonly assigned U.S. patent application Ser. No. 10/268,284, entitled “Electrochemical Processing Cell,” filed on Oct. 9, 2002, claiming priority to U.S. Provisional Application Ser. No. 60/398,345, filed on Jul. 24, 2002, both of which are incorporated herein by reference in their entireties to the extent not inconsistent herewith.

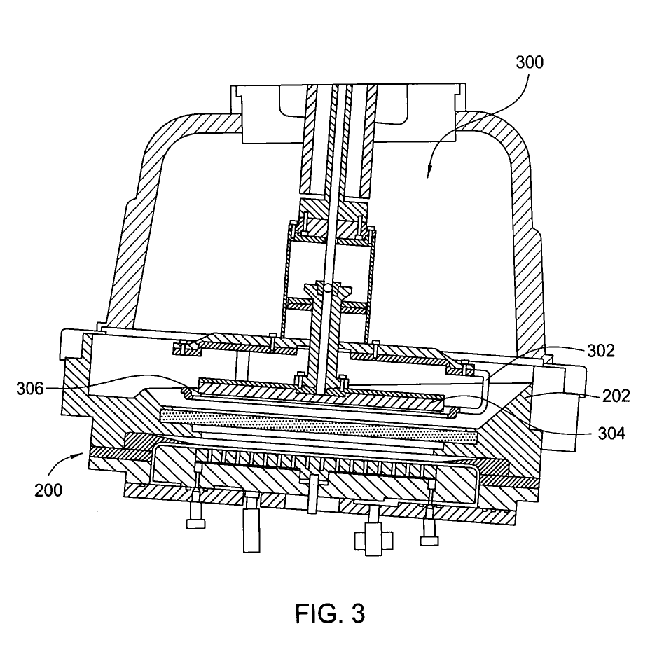

FIG. 3 illustrates a sectional view of a plating cell and head assembly positioned in a processing position. The head assembly 300 is further illustrated in commonly assigned U.S. patent application Ser. No. 10/781,040, entitled “Method For Immersing A Substrate,” filed on Feb. 18, 2004, claiming priority to U.S. Provisional Application Ser. No. 60/448,575, filed on Feb. 18, 2003, both of which are incorporated herein by reference in their entireties to the extent not inconsistent herewith. Once the substrate 306 is positioned on the contact ring 302, thrust plate assembly 304 is lowered into a processing position. A more detailed description of the thrust plate assembly 304 may be found in commonly assigned U.S. patent application Ser. No. 10/278,527, entitled “Plating Uniformity Control By Contact Ring Shaping,” filed on Oct. 22, 2002, which is hereby incorporated by reference in its entirety to the extent not inconsistent herewith. In one embodiment, the substrate may be tilted at an angle with respect to horizontal, and then vertically actuated toward the plating solution, while being rotated, which immerses the substrate and maintains a constant angle between the substrate and the upper surface of the plating solution.

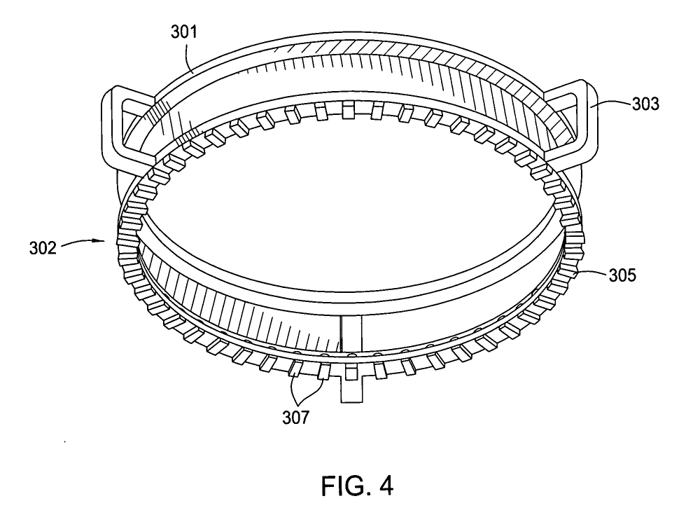

FIG. 4 illustrates a perspective view of an exemplary contact ring of the invention. Contact ring 302 generally includes an upper annular member 301, a lower substrate supporting member 305, and at least one support post member 303 connecting the upper annular member 301 to the lower substrate support member 305. The upper annular member 301 is generally configured to secure the contact ring 302 to the head assembly 300 (FIG. 3) that is configured to selectively position and rotate contact ring 302 during substrate processing. The lower substrate supporting member 305 is generally configured to receive and support a substrate (not shown) thereon for processing. Additionally, the supporting member 305 is also configured to electrically contact the substrate to provide an electrical processing bias thereto through contacts.

As discussed above with reference to FIG. 3, the substrate may be spun and/or immersed in the plating solution in a tilted orientation. These immersion protocols help to minimize bubble formation and adhesion of bubbles to the substrate surface during the immersion process. In addition, turbulence within inner basin 202 promotes the movement of bubbles toward the upper surface of the plating solution where they may flow over the weir of inner basin 202 into outer basin 201. However, bubbles coming into contact with the portions of contact ring 302 below the surface of the electroplating solution may adhere thereto. Specifically, rising bubbles adhering to contact ring 302 below the lowest level of the substrate may migrate upward across the substrate surface. In this sense, the affinity of bubbles to the surface of the contact ring may lead to defects during the plating process.

Embodiments of the invention generally provide a method for producing a contact ring surface of a desired wettability to minimize adherence of bubbles thereto. The contact ring 302 previously described contains supporting members 307 configured to electrically contact the substrate during processing. The supporting members 307 are made from a conductive material such as a metal. The surface of the contact ring 300 exclusive of the supporting members 307, however, is typically made from a non-conductive polymer material. This surface composition may be accomplished by coating a non-polymeric contact ring with a polymer material, or by fabricating the contact ring from, either entirely or partially, a polymeric material. Common polymers utilized include polyethylene, polypropylene, fluorinated polyalkylenes, polyaromatics, and other like materials.

Surfaces have varying tendencies to become wetted upon exposure to liquids. This phenomenon, typically referred to as wettability, manifests in aqueous systems as hydrophillicity or hydrophobicity. Relative wettability is generally quantified by measuring the contact angle of liquid droplets on the surface. This is accomplished, for example, by using a Rame-Hart goniometer apparatus, but may be achieved by use of any other suitable surface monitoring device, such as a camera. By this measurement process, a smaller contact angle corresponds to a more wettable surface. Embodiments of the present invention generally provide methods for modifying polymeric surfaces to improve wettability thereof.

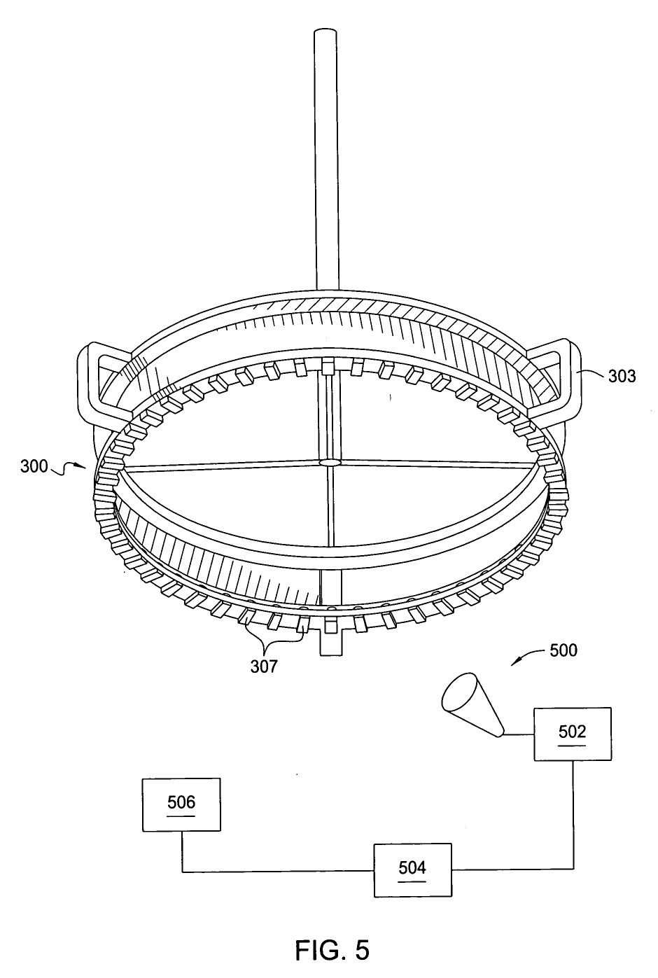

In one embodiment of the invention, the polymer surface of a contact ring is treated with ultraviolet (UV) radiation to modify the surface of the contact ring. FIG. 5 illustrates a process for modifying a contact ring surface through exposure to UV light. The contact ring 300 is positioned proximate a suitable UV source 500 and exposed to the radiation therefrom. UV source 500 is in communication with UV power source 502. A wettability sensor 506 is located proximate to the surface of contact ring 300 to be treated. The light source may be a UV lamp, eximer laser, diode, or other suitable device. More than one UV source may be employed to provide increased or more efficient surface coverage. In addition, the contact ring may be tilted at a desired angle to facilitate exposure. In one embodiment, the contact ring may be spun during the exposure process to allow for focusing of the radiation source in a narrower region.

Polymeric surface materials suitable for UV treatment include all organic polymers, such as, but are not limited to, polyalkylenes, polyaromatics, fluoropolymers, and mixtures and copolymers thereof. As discussed above, the polymer surface of the contact ring may comprise a polymeric coating of a contact ring made from, for example, a metal material, or the contact ring may itself be fabricated from a suitable polymer. In one embodiment, a metal contact ring coated (0.5 to 0.75 mm) with ethyl tetrafluoroethylene (ETFE) was UV irradiated. A 250 W pulsed/burst (2 microsecond) source (RC-250B UV lamp available from Xenon Corporation) was utilized. The treatment process was carried out for about 100 bursts. Wettability measurements of the ETFE surface before UV treatment indicated droplet contact angles of about 100 degrees. A steady decrease in droplet contact angle was observed by intermittent measurement. Final measurements subsequent to UV treatment showed droplet contact angles of 40-45 degrees. Not to be bound by theory, it is believed that the UV energy acts upon oxygen near the polymer surface to produce ozone. This process is known to occur at light wavelengths of <243 nm. It is hypothesized that ozone produced at the surface interacts with selected chemical bonds in the polymer to produce oxygenated moieties therein.

The UV source employed for embodiments of the present invention may be of any suitable intensity (wattage) depending on factors including, but not limited to, the initial wettability of the polymer surface, the desired final wettability of the polymer surface, the particular polymer to be surface modified, the distance between the UV source and the polymer surface, the surface area irradiated, oxygen content of treatment environment, presence or absence of liquid on polymer surface during treatment, and the number of UV sources employed. In addition, either a pulsed or continuous UV source may employed to advantage. One skilled in the art would understand the variables involved and be able to select an appropriate UV source.

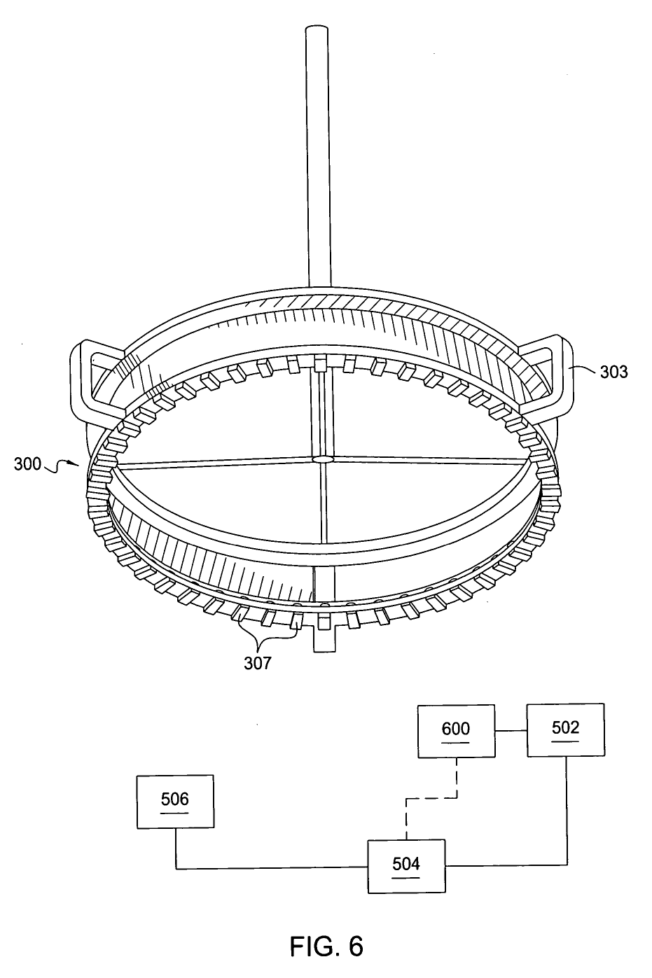

In other embodiments of the invention, the contact ring surface is treated with ozone to improve the wettability thereof. FIG. 6 shows a process for modifying a contact ring surface through exposure to ozone. The contact ring 300 is positioned proximate a suitable ozone source 600 and exposed to the ozone generated or contained therein and dispensed therefrom. Ozone source 600 may be an assembly comprising a container of pre-prepared ozone or alternatively may be an apparatus designed to generate and dispense ozone. In the latter embodiment, ozone source 600 is in communication with ozone power source 602. In the former, ozone treatment may involve manual control of ozone source 600 or mechanical control by a device such as controller 504, as is depicted by the dotted line therebetween. Wettability sensor 506 is located proximate to the surface of contact ring 300 to be treated. In one such embodiment, a polymer coated metal contact ring coated may be subjected to ozone gas supplied by an ozone generator, such as one available from Ozotech, Inc., of Yreka, Calif. Wettability measurements of the polymer surface before ozone treatment and subsequent to ozone treatment may be performed until a desired droplet contact angles is achieved.

Suitable ozone treatment process parameters include, but are not limited to, ozone flow rate, initial wettability of the polymer surface, the desired final wettability of the polymer surface, the particular polymer to be surface modified, presence or absence of liquid on polymer surface during treatment, and the surface area ozonized.

In a further embodiment of the present invention, the UV and ozone treatment processes would be combined to simultaneously or sequentially effect the modification of the contact ring surface. A combination of the processes would serve to minimize the time required to bring about the desired wettability improvements. Not to be bound by theory, it is believed that the presence of UV light accelerates the ozone surface modification by providing an additional mechanism for polymer oxidation. For example, it is known that irradiation of ozone at about 253.7 nm produces an activated oxygen species. The activated oxygen species produced may also interact with the polymer surface to bring about an oxidation thereof.

While the initial treatment of the polymer surface requires substantial time to effect the desired improvement in wettability, subsequent treatments of surfaces previously exposed to UV light, ozone, or a combination thereof require less time to achieve a target wettability. That is, while it is known that the surface effects of UV and ozone treatment are not permanent under certain electrochemical plating conditions, the decrease in surface wettability over time is gradual. As such, subsequent UV and/or ozone treatments can regenerate the desired surface wettability in a far shorter time frame than initial treatment. In one embodiment of the invention, a contact ring 300 previously treated by the method of the present invention is utilized in the abovementioned electrochemical plating apparatus to plate one or more substrates with a metal. Thereafter, between processing steps or during down time of the apparatus, the contact ring 300 may be subjected to further treatment with UV light and/or ozone to modify the polymer surface of the contact ring 300. Subsequent treatment or treatments may be carried out to generate a contact ring 300 surface with a similar level of wettability as previously produced, or the surface may be modified to produce a desired wettability greater than or less than the wettability level achieved by the initial treatment process.

Control of the surface modification process may be accomplished in several fashions. Measurement of the surface wettability may be performed subsequent to the UV and/or ozone exposure process. Alternatively, surface wettability may be monitored continuously or at various time intervals during the surface modification process. By the latter monitoring method, the desired surface wettability may be obtained with a lower possibility of over-treatment. In one embodiment, wettability sensor 506 is in communication with controller 504 which communicates with either UV source 500 (through UV power source 502) and/or ozone source 602 (either directly or through ozone power source 602), as applicable, to control application of the treating source based on the wettability level of contact ring 300 as it changes during the treatment process. Although FIGS. 5 and 6 depict separate application of UV energy and ozone, as describe above, the treatments may be combined and a treatment process wherein both a UV source and an ozone source are located proximate to a contact ring for treatment therewith may be advantageously employed.

In another series of embodiments of the present invention, the wettability of a contact ring surface is controlled by manipulating the process of forming the polymer surface layer. The polymer coating on a contact ring may be formed thereon by a process wherein a solid polymer is heated above its melt temperature and in liquid form is disposed upon the contact ring. The temperature of the polymer is then lowered below its melt temperature to form a solid surface layer. It is a feature of the present invention that the wettability of a polymer surface formed in this fashion may be controlled by variations in the polymer solidification phase of this process.

In various embodiments of the present invention, the solidification or freeze process includes a time period during which the surface of the liquefied polymer is subjected to temperatures substantially lower than the polymer melt temperature. In certain embodiments, the surface of the liquefied polymer is subjected to temperatures substantially lower than ambient air temperature. This exposure to relatively cold temperatures cools the polymer surface quickly. The quick cooling of the polymer surface (hereinafter “quench cooling”) produces a more wettable polymer surface. Not to be bound by theory, it is believed that the rapid solidification process affects the crystalline structure of the polymer surface at the molecular level. It is thought that a lesser degree of crystallinity at the polymer surface results in greater wettability.

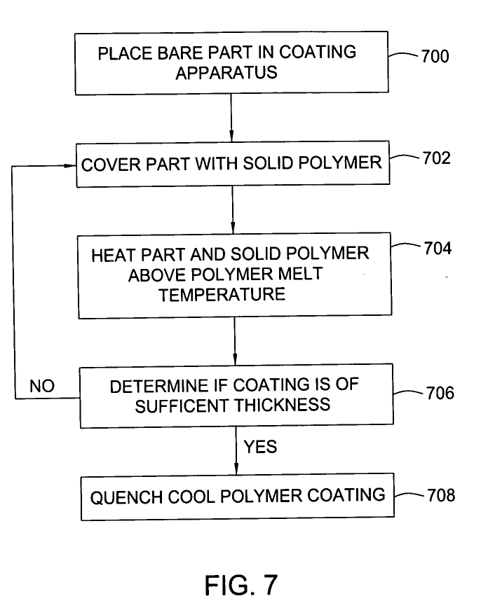

FIG. 7 shows a flow diagram describing an exemplary process sequence for controlling the wettability of a polymer surface. In step 700, a part to be coated with a polymer is placed in an appropriate coating apparatus. Although step 700 describes the part to be coated as a bare part, it is understood that the coating process of the present invention may be carried out on a previously coated component. Steps 702 and 704 generally describe the coating process. Step 706 involves a determination of sufficiency of coating inherent to any coating process. As is generally known in the art, the coating process may consist of one or more discreet melt/freeze steps. For application of coatings to contact rings, a polymer surface thickness of about 20 to 30 mils is typically desired. Importantly, when more than one melt/freeze step is employed, the polymer utilized to carry out each step may be the same polymer or different polymers. The polymer used in any melt/freeze step may be a single polymeric species or a mixture of different polymers. As is shown by step 708, when the desired thickness of polymer surface material is deposited on the contact ring, the top polymer layer is quench cooled to produce a polymer surface of the desired wettability. As previously described, the quench cooling process may be used to advantage when the contact ring is fabricated partially or entirely from a polymer material. In this aspect, the process described by FIG. 7 would be applicable by employing quench cooling step 708 during a cooling step of the fabrication process or by utilizing melt step 704 to liquefy a surface polymer material and then applying quench cooling step 708.

Suitable polymers for use in various embodiments of the invention wherein surface wettability is controlled by quench cooling of a melted polymer include, but are not limited to, polyalkylenes, polyaromatics, fluoropolymers, and mixtures and copolymers thereof. In addition, the quench cooled polymer surface may be a polymer coating applied to a non-polymeric contact ring or a polymer surface of a contact ring fabricated from a polymer material. A polymer coating for a non-polymeric contact ring may be produced from any suitable solid form of the polymer, including but not limited to, powder, pellets, flakes, and granules.

The quench cooling method of the present invention involves exposing a liquefied polymer to temperatures low enough to effect a rapid solidification of the polymer. This may be accomplished, for example, by treating the liquefied polymer surface with a cool fluid. Suitable gases for quench cooling by the present invention include, but are not limited to, air, nitrogen, helium, argon, and carbon dioxide. Suitable liquids include, but are not limited to, water, liquefied air, liquid nitrogen, and liquid carbon dioxide.

In one embodiment, a metal contact ring may be coated with a polymer and subjected to a quench cooling. Specifically, the metal contact ring is coated with the polymer in powder form and heated above the polymer melt temperature. As describe above with reference to FIG. 7, process steps 704, 706, and 708 are carried out. When a sufficient molten polymer layer has been built up, the surface of the liquefied polymer may then treated to quickly solidify the polymer surface. The quench cooling may consist of flowing ambient temperature (˜23° C.) air across the surface of the liquefied polymer with sufficient air flow to achieve a cooling profile that produces a polymer surface having the desired wettability properties. One skilled in the art would understand that the specific quench cooling conditions would vary depending on parameters including, but not limited to, the polymer(s) employed, the cooling agent used, the target polymer layer thickness, and the desired surface wettability.

In a further embodiments the wettability of a contact ring surface may be improved by combining various aspects of the present invention. For example, the abovementioned quench cooling process may be carried out in the presence of UV light and/or ozone. In one embodiment, the liquefied surface of the melted polymer would be exposed to UV light as part of the quench cooling process. In such an embodiment, the liquefied polymer surface could be irradiated with UV light before, during, and/or after the polymer surface cooling step. In another embodiment the liquefied polymer surface could be exposed to ozone as part of the quench cooling process. In such an embodiment, the liquefied polymer surface could be treated with ozone before, during, and/or after the polymer surface cooling step. Alternatively, cooled ozone gas could be utilized to both ozonize and quench cool the polymer surface. In additional embodiments, quench cooling in the presence of ozone could be carried out under UV irradiation to further control surface wettability.

The present invention provides several methods for producing contact rings for electrochemical plating systems having improved surface wettability. This improved wettability ameliorates the process of removing bubbles from electroplating solutions in a fashion that minimizes the likelihood of bubbles contacting the surface of the substrate being electroplated. As such, the electroplated substrates having fewer surface defects may be produced.

While the foregoing is directed to embodiments of the present invention, other and further embodiments of the invention may be devised without departing from the basic scope thereof, and the scope thereof is determined by the claims that follow.

1. A method for modifying the wettability of a contact ring polymer surface, comprising:
irradiating the polymer surface of the contact ring with ultraviolet radiation.

2. The method of claim 1, wherein the polymer surface of the contact ring comprises polyalkylenes, polyaromatics, fluoropolymers, copolymers thereof, or mixtures thereof.

3. The method of claim 1, wherein the contact ring is fabricated at least in part from a polymeric material.

4. The method of claim 1, wherein the ultraviolet radiation is generated from a source comprising one or more of the devices elected from the group consisting of lamps, eximer lasers, and diodes.

5. The method of claim 1, wherein the ultraviolet radiation is either pulsed or continuous.

6. The method of claim 1, wherein the ultraviolet radiation comprises light emitted at a wavelength of less than about 243 nm.

7. The method of claim 1, wherein a desired wettability of the contact ring polymer surface is obtained by measuring the wettability thereof during the irradiation process.

8. A method for modifying the wettability of a contact ring polymer surface, comprising:
exposing the polymer surface of the contact ring to ozone.

9. The method of claim 8, wherein the polymer surface of the contact ring comprises polyalkylenes, polyaromatics, fluoropolymers, copolymers thereof, or mixtures thereof.

10. The method of claim 8, wherein the contact ring is fabricated at least in part from a polymeric material.

11. The method of claim 8, wherein the ozone is produced by an ozone generation device.

12. The method of claim 8, wherein the ozone is provided by a container of ozone.

13. The method of claim 8, wherein a desired wettability of the contact ring polymer surface is obtained by measuring the wettability thereof during the ozination process.

14. The method of claim 1, further comprising:
exposing the polymer surface of the contact ring to ozone.

15. The method of claim 14, wherein the ultraviolet radiation comprises light emitted at a wavelength of about 253.7 nm.

16. A method for controlling the wettability of a contact ring polymer surface, comprising:
rapidly solidifying a liquefied polymer surface of the contact ring.

17. The method of claim 16, wherein the rapid solidification of the liquefied polymer surface is achieved by exposing at least a portion of the liquefied polymer surface to a fluid having an initial temperature substantially lower than ambient air temperature.

18. The method of claim 17, wherein the fluid comprises air, nitrogen, helium, argon, gaseous carbon dioxide, ozone, water, liquefied air, liquid nitrogen, liquid carbon dioxide, or combinations thereof.

19. The method of claim 16, wherein the liquefied polymer surface of the contact ring is produced by melting a solid polymeric material.

20. The method of claim 19, wherein the solid polymeric material comprises powder, pellets, flakes, granules, or combinations thereof.

21. The method of claim 16, further comprising one or more processes selected from the group consisting of:
irradiating the polymer surface of the contact ring with ultraviolet radiation; and
exposing the polymer surface of the contact ring to ozone.

22. The method of claim 21, wherein the process of irradiating the polymer surface of the contact ring with ultraviolet radiation, the process of exposing the polymer surface of the contact ring to ozone, or both process, are carried out in the time interval selected from the group consisting of:
before the process of rapidly solidifying the liquefied polymer surface of the contact ring;
during the process of rapidly solidifying the liquefied polymer surface of the contact ring;
after the process of rapidly solidifying the liquefied polymer surface of the contact ring; and
combinations thereof.

23. A contact ring produced from the method of claim 1.

24. A contact ring produced from the method of claim 8.

25. A contact ring produced from the method of claim 16.

26. A contact ring produced from the method of claim 21.
